(19) United States
(12) Patent Application Publication
(10) Pub. No.: US 2015/0253616 A1
(43) Pub. Date: Sep. 10, 2015

(54) DISPLAY APPARATUS

(71) Applicant: SAMSUNG ELECTRONICS CO., LTD., Suwon-si (KR)

(72) Inventor: Jeong Shan NA, Hwaseong-si (KR)

(73) Assignee: SAMSUNG ELECTRONICS CO., LTD., Suwon-si (KR)

(21) Appl. No.: 14/643,337

(22) Filed: Mar. 10, 2015

(30) Foreign Application Priority Data
Mar. 10, 2014 (KR) 10-2014-0027587

(51) Int. Cl. G02F 1/1333; G02F 1/1335

(52) U.S. Cl. CPC G02F 1/133308; G02F 1/133528; G02F 2001/13332; G02F 2001/133322; G02F 2201/46

(57) ABSTRACT

A display apparatus capable of preventing a display panel from being damaged due to temperature, humidity, or dust through an improved top chassis structure, is provided. The display apparatus can be implemented to have improved image definition by preventing a light leakage phenomenon. The display apparatus includes a display panel configured to form an image, and a top chassis provided on one side of the display panel and having an opening formed to expose the display panel, wherein a receiving portion into which part of the display panel is inserted is formed in the top chassis.

### CROSS-REFERENCE TO RELATED APPLICATION

This application claims the benefit of Korean Patent Application No. 10-2014-0027587, filed on Mar. 10, 2014 in the Korean Intellectual Property Office, the disclosure of which is incorporated herein by reference in its entirety.

### BACKGROUND

1. Field

An apparatus consistent with exemplary embodiments relates to a display apparatus having an improved structure of a top chassis.

2. Description of the Related Art

In general, display apparatuses visually display data/information such as characters and graphics. The display apparatus includes a liquid crystal display (LCD) apparatus and a frame on which the LCD apparatus is mounted.

Because the LCD apparatus is a passive optical element that does not autonomously emit light, an image may be displayed using a backlight assembly attached to a rear surface of a display panel. The size and optical efficiency of the LCD apparatus and the like differ according to a structure of the backlight assembly and overall mechanical and optical characteristics of the LCD apparatus are significantly affected thereby.

The backlight assembly can be classified into a direct type and an edge type according to a position of a light source. The direct type backlight assembly directly provides the overall surface of a liquid crystal panel with light by placing a light source on a lower surface of the panel. The edge type backlight assembly has a light source provided on one side behind the liquid crystal panel.

### SUMMARY

Therefore, it is an aspect of an exemplary embodiment to provide a display apparatus capable of implementing the highest quality of image by improving a top chassis.

Additional aspects of an exemplary embodiment will be set forth in part in the description which follows and, in part, will be obvious from the description, or may be learned by practice of the invention.

In accordance with one aspect of an exemplary embodiment, a display apparatus includes: a display panel configured to form an image; and a top chassis provided on one side of the display panel and having an opening formed to expose the display panel, wherein a receiving portion into which part of the display panel is inserted is formed in the top chassis.

The receiving portion may be provided in the form of a groove on an inner side surface of the top chassis.

The receiving portion may be formed to cover an end of the display panel.

The top chassis may include: a bezel configured to cover an edge of a front surface of the display panel; and a top side surface provided to be bent in a rear direction from an end of the bezel. The receiving portion may be provided in a form of a groove that is parallel to the bezel.

The receiving portion may be provided on an inner side of the top side surface.

The display panel may be inserted into the receiving portion and fixed by a fixation member.

The fixation member may include an adhesive or an adhesive tape.

The receiving portion may be provided with a buffer member.

The buffer member may be provided to substantially cover an inner side surface of the top chassis forming the receiving portion.

The buffer member may be provided to partially cover an inner side surface of the top chassis having formed therein the receiving portion so that the display panel is not in contact with the inner side surface of the top chassis.

The buffer member may be formed of a synthetic resin with an elastic force.

The display panel may include: an LCD module configured to form the image: and a polarization sheet arranged on at least one side of the LCD module.

An end of the LCD module may be inserted into the receiving portion.

The receiving portion may be formed to correspond to a shape of an end of the LCD module.

The top chassis may be injection-molded to include the receiving portion.

In accordance with another aspect of an exemplary embodiment, a display apparatus includes: a display panel configured to form an image; and a chassis configured to house the display panel, wherein a receiving portion in which an end of the display panel is inserted and fixed is formed in an inner side surface of the chassis.

The chassis may include: a top chassis arranged on one side of the display panel; and a bottom chassis arranged on another side of the display panel.

The receiving portion may be provided in the inner side surface of the top chassis in the form of a groove corresponding to a shape of an end of the display panel.

A buffer member may be arranged between the inner side surface of the chassis forming the receiving portion and an end of the display panel inserted into the receiving portion.

Airtightness may be maintained inside the chassis if the end of the display panel is inserted into the receiving portion and fixed.

According to the above-described aspects of an exemplary embodiment, it is possible to prevent a display panel from being damaged due to temperature, humidity, or dust through an improved top chassis structure. In addition, it is possible to implement a display apparatus having improved image definition by preventing a light leakage phenomenon.

### BRIEF DESCRIPTION OF THE DRAWINGS

These and/or other aspects of the exemplary embodiments will become apparent and more readily appreciated from the following description of the embodiments, taken in conjunction with the accompanying drawings of which:

FIG. 1 is a perspective view illustrating a display apparatus according to an exemplary embodiment;

FIG. 2 is an exploded perspective view illustrating the display apparatus according to an exemplary embodiment;

FIG. 3 is a cross-sectional view illustrating part of the display apparatus according to an exemplary embodiment;

FIG. 4 is a view illustrating a top chassis and part of a display panel according to an exemplary embodiment;

FIG. 5 is a cross-sectional view illustrating part of a display apparatus according to another exemplary embodiment; and

FIG. 6 is a cross-sectional view illustrating part of a display apparatus according to still another exemplary embodiment.

### DETAILED DESCRIPTION

Reference will now be made in detail to the exemplary embodiments, examples of which are illustrated in the accompanying drawings, wherein like reference numerals refer to like elements throughout.

Hereinafter, a display apparatus according to an exemplary embodiment will be described in detail with reference to the drawings.

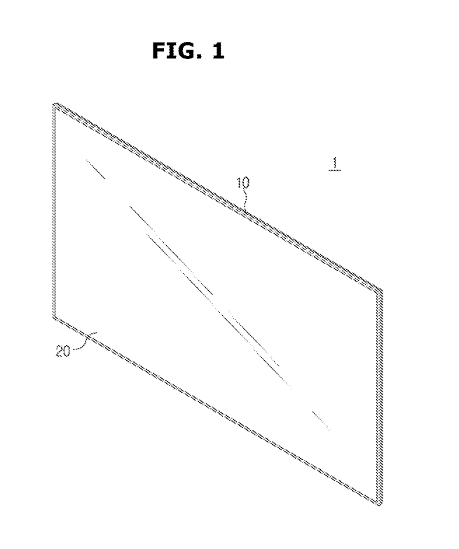

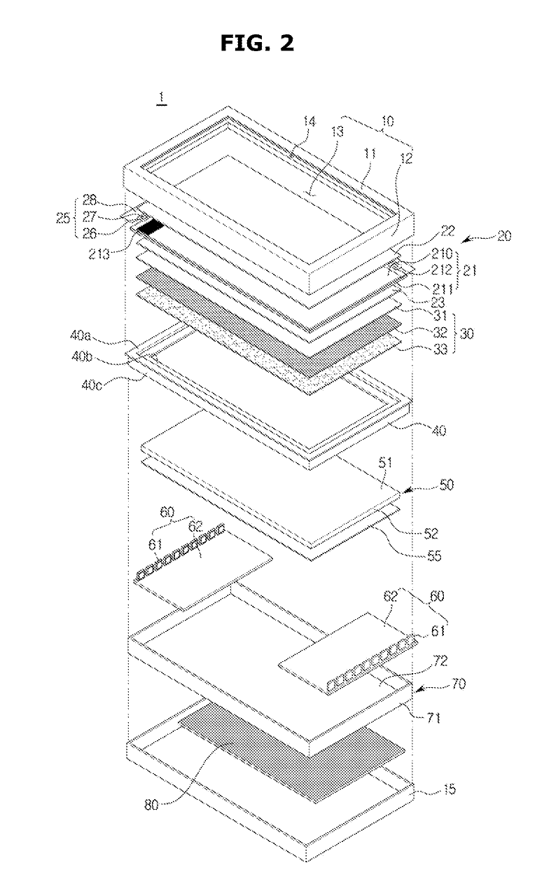

FIG. 1 is a perspective view illustrating a display apparatus according to an exemplary embodiment, and FIG. 2 is an exploded perspective view illustrating the display apparatus according to an exemplary embodiment.

Referring to FIGS. 1 and 2, a display apparatus 1 according to an exemplary embodiment includes a top chassis 10, a display panel 20, a backlight unit 60, and a bottom chassis 70. The top chassis 10 is disposed in front of the display panel 20. The backlight unit 60 is disposed behind and separated from the display panel 20. The bottom chassis 70 may be disposed behind the display panel 20 and the backlight unit 60.

A middle mold 40 may be further provided between the display panel 20 and the backlight unit 60. The middle mold 40 may be separated from the backlight unit 60. Behind the bottom chassis 70, a heat emitting sheet 80 may be disposed. Behind the bottom chassis 70, a rear cover 15 forming a rear exterior of the display apparatus 1 may be provided.

Behind the display panel 20, a plurality of optical sheets 30 may be provided. Behind the optical sheets 30, a light guide plate 50 may be arranged. Behind the light guide plate 50, a reflective sheet 55 may be disposed.

The optical sheet 30 includes a protective film 31, a prism film 32, and a diffusion film 33. The protective film 31 is disposed in front of the prism film 32 and protects the prism film 32 sensitive to dust or scratches.

On a front surface of the prism film 32, a triangular prism may be disposed (not shown). The prism film 32 may concentrate light diffused from the diffusion film 33 in a direction perpendicular to a rear surface of the display panel 20 in a forward direction. Two prism films 32 may be used. Light passing through the prism film 32 moves in a perpendicular direction toward the display panel 20, so that the display panel 20 may be configured to have uniform luminance.

On the diffusion film 33, a bead-like coating layer may be formed. Light passing through the light guide plate 50 may be diffused by the diffusion film 33 and supplied to the display panel 20.

The light guide plate 50 may cause light emitted from a light-emitting diode (LED) 61 to be uniformly supplied to the diffusion film 33. The light guide plate 50 may be formed of an acrylic resin such as polymethyl methacrylate (PMMA) or polymethylstrene.

The light guide plate 50 may include an emission plane 51 and an incidence plane 52. The emission plane 51 can be arranged behind the diffusion film 33 and face one surface of the diffusion film 33. The incidence plane 52 is provided on a side section and light emitted from the LED 61 may be incident on the incidence plane 52.

The reflective sheet 55 may be disposed behind the light guide plate 50. Light emitted through a lower surface of the light guide plate 50 by the reflective sheet 55 may be guided to the light guide plate 50 again. The reflective sheet 55 may be made of a plastic material such as polyethylene terephtalate (PET) or polycarbonate (PC).

The backlight unit 60 includes a plurality of LEDs 61 and a printed circuit board (PCB) 62. The LEDs 61 may supply light to the light guide plate 50. The plurality of LEDs 61 may be installed on the PCB 62.

The plurality of LEDs 61 may be installed to protrude from one surface of the PCB 62. The plurality of LEDs 61 may be disposed to be separated at predetermined intervals on the one surface of the PCB 62. The plurality of LEDs 61 may be provided on a left or right side of the reflective sheet 55. The plurality of LEDs 61 may emit light in a direction perpendicular to a direction in which the plurality of LEDs 61 protrude on the PCB 62. The layout of the plurality of LEDs is not limited thereto. For example, the plurality of LEDs may be disposed in front of the reflective sheet 55 so that light can be emitted toward the light guide plate 50. Hereinafter, an example in which the plurality of LEDs 61 are provided on the left or right side of the reflective sheet 55 will be described.

The PCB 62 may be arranged behind the reflective sheet 55. The PCB 62 may be fixed to the bottom chassis 70 through a fastening member such as a screw or an adhesive means such as a double-sided tape. In the PCB 62, a backside opposite to a side on which the plurality of LEDs 61 are installed may be fixed to a bottom surface 72 of the bottom chassis 70.

The LEDs 61 may be a plurality of LEDs which emit white light, and may be constituted of a combination of a plurality of LEDs which emit red, green, and blue light.

The display panel 20 may include a first substrate 211 having a thin film transistor (TFT) and a pixel electrode and a second substrate 210 arranged on one side of the first substrate 211 and having a color filter and a drive source. A liquid crystal layer 212 may be provided between the first substrate 211 and the second substrate 210. A polarization sheet 22 or 23 may be attached to a lower surface of the first substrate 211 or an upper surface of the second substrate 210. A module in which the first substrate 211, the second substrate 210, and the liquid crystal layer 212 are combined may be referred to as an LCD module 21.

A drive member 25 for applying a drive signal may be provided on one side of the first substrate 211. The drive member 25 may include a flexible PCB 26, a drive chip 27, and a circuit board 28. The drive chip 27 may be mounted on one side of the flexible PCB 26. The circuit board 28 may be connected to the other side of the flexible PCB 26.

The flexible PCB 26 may be provided in a chip on film (COF) scheme in which a chip device is mounted on a base film. The flexible PCB 26 may be a tape carrier package (TCP) or a chip on glass (COG) form using tape automated boding (TAP) technology.

A black matrix 213 may be formed on the second substrate 210, and a color filter (not illustrated) may be formed in the black matrix 213. For example, the black matrix 213 may be made of an organic material including chrome oxide or black pigment. The color filter may be regularly formed and three sub-layers (not illustrated) having different colors may be repeatedly formed.

The display panel 20 can form a screen by adjusting an arrangement of the liquid crystal layer 212. The display panel 20 may receive light from the backlight unit 60 to display a video, since the display panel 20 is a non light-emitting element.

The top chassis 10 may include a bezel 11 and a top side surface 12. The bezel 11 may cover an edge of a front surface of the panel 20. The top side surface 12 may be bent in a rear direction away from an end of the bezel 11. At least part of the top side surface 12 may be in contact with the bottom chassis 70. For example, at least part of the top side surface 12 may cover an outer side surface of a bottom side surface 71.

In the top chassis 10, an opening 13 may be formed to expose the display panel 20. A valid display region on which the screen is actually displayed in the display panel 20 can be exposed on an overall surface through the opening 13. The bottom chassis 70 may include a bottom side surface 71 and a bottom surface 72. The bottom side surface 71 may be extended to protrude in a front direction along the circumference of the bottom surface 72. On the bottom surface 72, a backlight unit 60 may be seated. The heat emitting sheet 80 may be disposed behind the bottom surface 72 of the bottom chassis 70.

The middle mold 40 may include a first support member 40a, a second support member 40b, and an extension member 40c. The first support member 40a and the second support member 40b may be formed to extend to an inner side of the middle mold 40. The second support member 40b may be extended internally from the first support member 40a and extended to form a step in a rear direction from the first support member 40a. The extension member 40c is extended behind the middle mold 40. Part of the display panel 20 may be supported by the first support member 40a. Part of the optical sheet 30 may be supported by the second support member 40b. An outer side surface of the extension member 40c may be in contact with an inner side surface of the bottom chassis 70.

The LED 61 may simultaneously radiate light and heat. The PCB 62 may perform a function of externally transferring heat generated from the LED 61 as well as a function of supplying a drive signal to the LED 61. That is, the heat generated from the LED 61 may be transferred to the side of the bottom chassis 70 through the PCB 62. In order to increase heat transfer efficiency, the PCB 62 may be manufactured of a metal having a high thermal conduction rate. For example, the PCB 62 may be manufactured of a metallic material including aluminum, copper, or the like.

The heat emitting sheet 80 may be mounted behind the bottom chassis 70. A heat emission function of the side of the bottom chassis 70 may be improved by the heat emitting sheet 80.

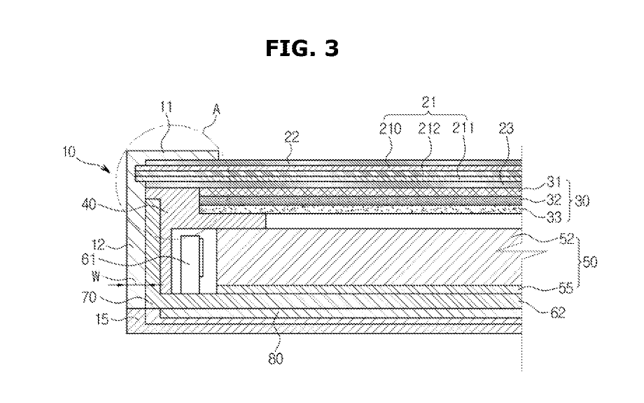

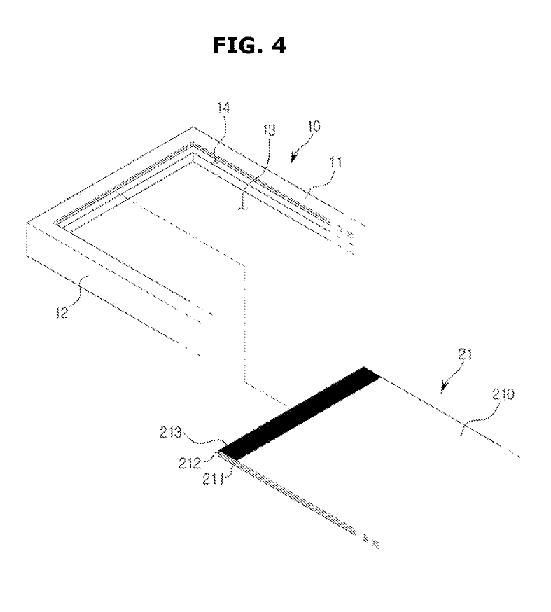

FIG. 3 is a cross-sectional view illustrating part of the display apparatus according to an exemplary embodiment, and FIG. 4 is a view illustrating the top chassis and part of the display panel according to an exemplary embodiment.

Referring to FIGS. 3 and 4, the receiving portion 14, or receiving part, into which part of the LCD module 21 may be inserted may be included on one side of the top chassis 10 of the display apparatus 1 according to an exemplary embodiment. The receiving portion 14 may be formed on an inner side surface of the top chassis 10. Specifically, the receiving portion 14 may be formed on the inner side surface of the top side surface 12 to cover an end of the LCD module 21. The receiving portion 14 may be provided on an inner side of the top side surface 12 in the form of a groove formed in parallel to the bezel 11. In the receiving portion 14, the end of the LCD module 21 in which the first substrate 211, the liquid crystal layer 212, and the second substrate 210 are combined may be housed. The receiving portion 14 is provided in a form corresponding to a shape of a stair step of the LCD module 21, and there is no empty space in the receiving portion 14 if the LCD module 21 is housed in the receiving portion 14. When the end of the LCD module 21 is inserted into the receiving portion 14 and fixed, airtightness may be maintained in a space in which the top chassis 10 and the bottom chassis 70 are formed.

The top chassis 10 may be injection-molded with a metallic material such as an aluminum alloy material. The receiving portion 14 may be provided through injection molding in which the receiving portion 14 is concaved in the form of a groove longitudinally extending on one side of the top chassis 10 at the time of injection molding of the top chassis 10. A width of the receiving portion 14 may be formed to be smaller than a width w of the existing top chassis 10. The receiving portion 14 may be formed so that the width w of the existing top chassis 10 does not increase. Thus, a thickness of the bezel may not increase.

The end of the LCD module 21 may be housed in the receiving portion 14 and fixed by a fixation member such as an adhesive or an adhesive tape. Means for inserting and fixing the end of the LCD module 21 inside the receiving portion 14 is not limited thereto.

The receiving portion 14 is provided on one side of the top chassis 10 and the end of the LCD module 21 is housed in the receiving portion 14, so that light emitted from the LED 61 arranged behind the LCD module 21 is prevented from being externally leaked through a gap between the top chassis 10 and the LCD module 21. In this manner, it is possible to improve the definition of image quality of the display apparatus 1 by preventing light emitted from the LED 61 from being leaked.

In addition, because the inside and outside of the display apparatus 1 are blocked by the LCD module 21, it is possible to minimize an influence of the external temperature, humidity, or dust or the like applied to the optical sheet, the light guide plate, the PCB, and the like arranged within a space in which the top chassis 10 and the bottom chassis 70 are formed. Accordingly, it is possible to prevent the device damage or control error from occurring due to the influence of the external temperature or humidity or the like on the display apparatus 1.

The receiving portion 14 which is a space in which the end of the LCD module 21 is housed is not provided in a separate configuration and is provided on an inner side surface of the top chassis 10. Thereby, the cost of materials required to provide the receiving portion as a separate configuration can be reduced and the shape of the display apparatus 1 may not be changed.

Although an example in which the receiving portion 14 is formed on the inner side surface of the top chassis 10 has been described with reference to FIGS. 3 and 4, this description of the receiving portion 14 into which the end of the LCD module 21 is inserted is not limited thereto. For example, the receiving portion 14 may be formed on one side of the middle mold 40 or an inner side surface of the bottom chassis 70.

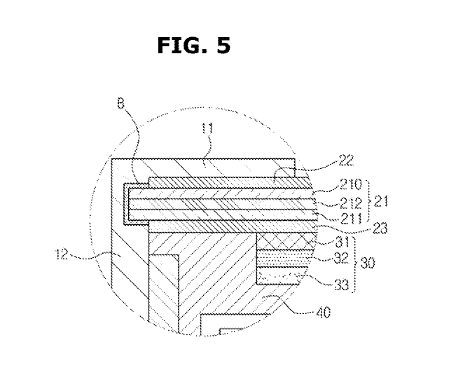

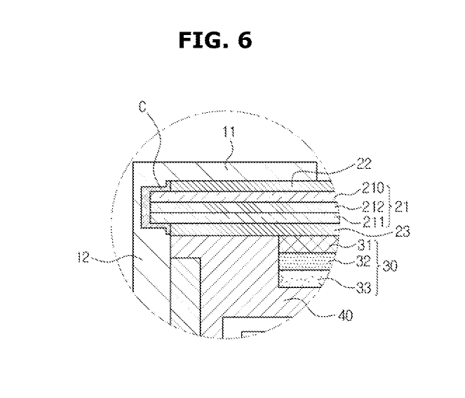

FIG. 5 is a cross-sectional view illustrating part of a display apparatus according to another exemplary embodiment, and FIG. 6 is a cross-sectional view illustrating part of a display apparatus according to still another exemplary embodiment.

Referring to FIGS. 5 and 6, buffer members B and C may be provided in the top chassis 10 to protect the LCD module 21 from the external impact. The buffer members B and C may be formed of a synthetic resin having an elastic force such as silicone or polyurethane.

As illustrated in FIG. 5, the display apparatus 1 according to the other exemplary embodiment may include the buffer member B provided on the inner side surface of the top chassis 10 forming the receiving portion 14. The buffer member B may be provided to cover the overall inner side surface forming the receiving portion 14 or provided so that the LCD module 21 is not in contact with an inner side wall forming the receiving portion 14 when the buffer member B is formed on part of the inner side surface and the end of the LCD module 21 is inserted into the receiving portion 14.

In this manner, the buffer member B is provided in the receiving portion 14, so that the buffer member B can prevent the LCD module 21 from being damaged even when the external impact is applied to the display apparatus 1. In addition, the buffer member B can improve the airtightness of the side of the receiving portion 14. Thereby, the external humidity or dust or the like can be prevented from entering the display apparatus 1 and affecting the optical sheet 30, the light guide plate 50, or the like.

As illustrated in FIG. 6, the buffer member C according to still another exemplary embodiment may be provided to be in contact with part of a constituent element adjacent to the LCD module 21 as well as the inner side surface of the top chassis 10 forming the receiving portion 14. For example, the buffer member C may be extended to make contact with side surfaces of the polarization sheets 22 and 23 and the like which are constituent elements adjacent to the LCD module 21 in addition to the LCD module 21. The external impact applied to the LCD module 21, the polarization sheets 22 and 23, and the like may be mitigated by the buffer member C. Therefore, it is possible to prevent the display panel 20 from being damaged by the external impact.

Although an example in which the end of the LCD module 21 is housed in the receiving portion 14 provided in the top chassis 10 has been described above, one end of the display panel 20 including the LCD module 21 and the polarization sheets 22 and 23 may be housed in the receiving portion 14. In addition, a formation position of the receiving portion 14 is not limited thereto and may be formed in the middle mold 40, the bottom chassis 70, or the like.

Although a few exemplary embodiments have been shown and described, it would be appreciated by those skilled in the art that changes may be made in these exemplary embodiments without departing from the principles and spirit of the invention, the scope of which is defined in the claims and their equivalents.

1. A display apparatus comprising:
a display panel configured to form an image; and
a top chassis provided on one side of the display panel and having an opening formed to expose the display panel,
wherein a receiving portion into which part of the display panel is inserted is formed in the top chassis.

2. The display apparatus according to claim 1, wherein the receiving portion is provided in a form of a groove on an inner side surface of the top chassis.

3. The display apparatus according to claim 2, wherein the receiving portion is formed to cover an end of the display panel.

4. The display apparatus according to claim 1, wherein the top chassis includes:
a bezel configured to cover an edge of a front surface of the display panel; and
a top side surface provided to be bent in a rear direction from an end of the bezel.

5. The display apparatus according to claim 4, wherein the receiving portion is provided on an inner side of the top side surface.

6. The display apparatus according to claim 1, wherein the display panel is inserted into the receiving portion and fixed by a fixation member.

7. The display apparatus according to claim 6, wherein the fixation member comprises one from among an adhesive and an adhesive tape.

8. The display apparatus according to claim 1, wherein the receiving portion is provided with a buffer member.

9. The display apparatus according to claim 8, wherein the buffer member substantially covers an inner side surface of the top chassis forming the receiving portion.

10. The display apparatus according to claim 8, wherein the buffer member partially covers an inner side surface of the top chassis having formed therein the receiving portion so that the display panel is not in contact with the inner side surface of the top chassis.

11. The display apparatus according to claim 8, wherein the buffer member is formed of a synthetic resin with an elastic force.

12. The display apparatus according to claim 1, wherein the display panel includes:
a liquid crystal display (LCD) module configured to form the image: and
a polarization sheet arranged on at least one side of the LCD module.

13. The display apparatus according to claim 12, wherein an end of the LCD module is inserted into the receiving portion.

14. The display apparatus according to claim 12, wherein the receiving portion is formed to correspond to a shape of an end of the LCD module.

15. The display apparatus according to claim 1, wherein the top chassis is injection-molded to include the receiving portion.

16. A display apparatus comprising:
a display panel configured to form an image; and
a chassis configured to house the display panel,
wherein a receiving portion in which an end of the display panel is inserted and fixed is formed in an inner side surface of the chassis.

17. The display apparatus according to claim 16, wherein the chassis includes:
a top chassis arranged on one side of the display panel; and
a bottom chassis arranged on another side of the display panel.

18. The display apparatus according to claim 17, wherein the receiving portion is provided in the inner side surface of the top chassis in a form of a groove corresponding to a shape of an end of the display panel.

19. The display apparatus according to claim 16, wherein a buffer member is arranged between the inner side surface of the chassis forming the receiving portion and an end of the display panel inserted into the receiving portion.

20. The display apparatus according to claim 16, wherein airtightness is maintained inside the chassis if an end of the display panel is inserted into the receiving portion and fixed.

21. The display apparatus according to claim 5, wherein the receiving portion is provided in a form of a groove that is parallel to the bezel.
